(19) United States
(12) Patent Application Publication
(10) Pub. No.: US 2023/0382218 A1
(43) Pub. Date: Nov. 30, 2023

(54) VEHICLE FUEL TANK STRUCTURE

(71) Applicant: Mazda Motor Corporation, Hiroshima (JP)

(72) Inventors: Tsuyoshi FURUNO, Hiroshima (JP); Yusuke AKASAKI, Hiroshima (JP); Ryuichi UEDA, Hiroshima (JP); Takuya FUJIMOTO, Hiroshima (JP)

(73) Assignee: Mazda Motor Corporation, Hiroshima (JP)

(21) Appl. No.: 18/126,479

(22) Filed: Mar. 27, 2023

(30) Foreign Application Priority Data
May 30, 2022 (JP) 2022-087500

(51) Int. Cl. B60K 15/067

(52) U.S. Cl. CPC B60K 15/067; B60K 2015/0634

(57) ABSTRACT

A vehicle fuel tank structure capable of suppressing transmission of a vibration of a fuel pump to a vehicle body without depending on a rubber mount includes a fuel tank provided below floor panels; a fuel pump which is provided inside the fuel tank and which is fixed by being pressed against a tank bottom surface of the fuel tank; and a reinforcement member fixed to a vehicle-exterior side of the tank bottom surface against which the fuel pump is pressed, in which the reinforcement member includes a first fixation portion which is fixed to the fuel tank at a position overlapping with a section against which the fuel pump is pressed in a plan view; and second fixation portions which are fixed to the fuel tank at positions not overlapping with the section against which the fuel pump is pressed in a plan view.

### CROSS-REFERENCE TO RELATED APPLICATION

The present application claims priority to Japanese Patent Application No. 2022-087500, filed on May 30, 2022, the entire contents of which are incorporated herein by reference.

### BACKGROUND

### Field

The present disclosure relates to a vehicle fuel tank structure and, more specifically, to a vehicle fuel tank structure including a fuel tank provided below a floor panel and a fuel pump unit which is provided inside the fuel tank and which is fixed by being pressed against a tank bottom surface of the fuel tank.

### Description of the Related Art

Generally, a fuel pump unit is provided inside a fuel tank mounted to a vehicle. Since a tank bottom surface of the fuel tank against which the fuel pump unit is pressed has a planar shape, there is a problem in that, depending on vibration characteristics of the fuel pump unit, a vibration of the tank bottom surface is transmitted to a vehicle body.

As means for suppressing the transmission of the vibration to the vehicle body, a structure disclosed in Patent Literature 1 is known.

Specifically, the structure disclosed in Patent Literature 1 described above is a structure in which a flange portion which protrudes outward is provided on an outer circumference of a fuel tank and the fuel tank is fixed to a vehicle body by interposing anti-vibration rubber between the flange portion and the vehicle body, and a so-called rubber mount structure is adopted.

However, when a center tank layout is adopted in which a battery unit is mounted in a rear part of the vehicle body and a fuel tank is mounted in front of the battery unit at center in a vehicle width direction, since the fuel tank is fixed to a feet position of a rear seat occupant, a vibration from the fuel tank is transmitted to the vehicle body, and a vibration perceived by the rear seat occupant becomes prominent, there is a need to suppress the transmission of the vibration from the fuel tank to the vehicle body.

### CITATION LIST

### Patent Literature

[Patent Literature 1] Japanese Patent Laid-Open No. 2016-74331

### SUMMARY

### Problems to be Solved

In consideration thereof, an object of the present disclosure is to provide a vehicle fuel tank structure capable of suppressing transmission of a vibration of a fuel pump unit to a vehicle body without depending on a rubber mount.

### Solutions to the Problems

The present disclosure describes a vehicle fuel tank structure including: a fuel tank provided below a floor panel; a fuel pump unit which is provided inside the fuel tank and which is fixed by being pressed against a tank bottom surface of the fuel tank; and a reinforcement member fixed to a vehicle-exterior side of the tank bottom surface against which the fuel pump unit of the fuel tank is pressed, the vehicle fuel tank structure characterized in that the reinforcement member includes: a first fixation portion which is fixed to the fuel tank at a position overlapping with a section against which the fuel pump unit is pressed in a plan view; and a second fixation portion which is fixed to the fuel tank at a position not overlapping with the section against which the fuel pump unit is pressed in a plan view.

According to the present disclosure, although vibration from a fuel pump of the fuel pump unit is transmitted to the tank bottom surface, since the reinforcement member is fixed by the first fixation portion to be a vibration generation position and the second fixation portion at a position spaced from the vibration generation position, rigidity of the tank bottom surface in a periphery of a vibration source is improved and vibration of the fuel tank can be suppressed.

Therefore, the transmission of the vibration of the fuel pump unit to the vehicle body can be suppressed without depending on a rubber mount.

As an aspect of the present disclosure, the second fixation portion may include a plurality of fixation portions, and the first fixation portion may be disposed on an imaginary line connecting the plurality of second fixation portions to each other.

According to the present disclosure, since the first fixation portion is pressed via the reinforcement member at the second fixation portions which are positioned on the imaginary line, a vibration of the first fixation portion to be a vibration generation position can be suppressed in an efficient manner.

In addition, as an aspect of the present disclosure, a tank band for supporting the fuel tank may be disposed between the first fixation portion and the second fixation portion on a rear side.

According to the present disclosure, by causing the reinforcement member to press against the tank bottom surface including the tank band, the vibration of the tank bottom surface can be further suppressed.

Furthermore, as an aspect of the present disclosure, the reinforcement member may include a ridge portion which protrudes upward and which houses the tank band.

According to the present disclosure, suppression of the vibration of the tank bottom surface can be achieved by suppressing a bending deformation of the reinforcement member due to input of vibration in an up-down direction with the ridge portion and the tank band which is housed in the ridge portion.

Moreover, as an aspect of the present disclosure, the tank bottom surface of the fuel tank and the reinforcement member may be disposed spaced from each other in the up-down direction.

According to the present disclosure, due to the reinforcement member being spaced from the tank bottom surface in the up-down direction, the reinforcement member can be made a structure capable of increasing a moment of inertia of area and, accordingly, an improvement in rigidity can be achieved.

In addition, as an aspect of the present disclosure, the tank bottom surface of the fuel tank may include a raised wall which protrudes toward an inside of the tank from the tank bottom surface and which covers a circumference of the fuel pump unit, and the reinforcement member may be disposed at a position which opposes an inside area of the raised wall.

According to the present disclosure, the inside area of the raised wall with low rigidity can be reinforced in an efficient manner by the reinforcement member while eliminating a deficiency in fuel intake of the fuel pump during rolling of the vehicle with the raised wall.

Furthermore, as an aspect of the present disclosure, the tank bottom surface against which the fuel pump unit is pressed may be constructed as a flat surface.

According to the present disclosure, although the tank bottom surface constructed by a flat surface readily deforms, the tank bottom surface can be reliably reinforced by the reinforcement member which is fixed by the first fixation portion and the second fixation portion.

### Advantageous

According to the present disclosure, the transmission of the vibration of the fuel pump unit to the vehicle body can be suppressed without depending on a rubber mount.

### BRIEF DESCRIPTION OF DRAWINGS

FIG. 1 is a bottom view of a substantial part of a vehicle including a vehicle fuel tank structure.

FIG. 2 is an enlarged view of a substantial part of FIG. 1.

FIG. 3 is a bottom view of a fuel tank structure shown in a state where a tank band has been removed from FIG. 2.

FIG. 4 is a bottom view of the fuel tank structure shown in a state where a reinforcement member has been removed from FIG. 3.

FIG. 5 is a cross-sectional arrow view of a substantial part taken along a line A-A in FIG. 2.

FIG. 6 is a cross-sectional arrow view of a substantial part taken along a line B-B in FIG. 2.

FIG. 7 is a top perspective view which partially shows an internal structure of a fuel tank lower portion.

FIG. 8 shows a schematic perspective view of a fuel pump unit.

### DETAILED DESCRIPTION

Suppressing transmission of a vibration of a fuel pump unit to a vehicle body without depending on a rubber mount is realized by a configuration including: a fuel tank provided below a floor panel; a fuel pump unit which is provided inside the fuel tank and which is fixed by being pressed against a tank bottom surface of the fuel tank; and a reinforcement member fixed to a vehicle-exterior side of the tank bottom surface against which the fuel pump unit of the fuel tank is pressed, wherein the reinforcement member includes: a first fixation portion which is fixed to the fuel tank at a position overlapping with a section against which the fuel pump unit is pressed in a plan view; and a second fixation portion which is fixed to the fuel tank at a position not overlapping with the section against which the fuel pump unit is pressed in a plan view.

### Example

Hereinafter, the present disclosure will be described in detail with reference to the drawings.

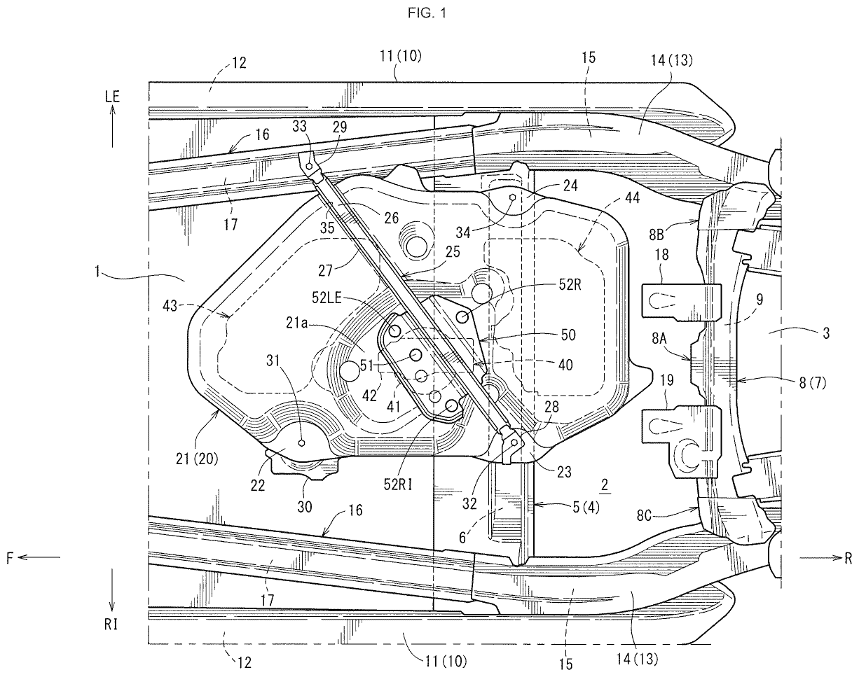

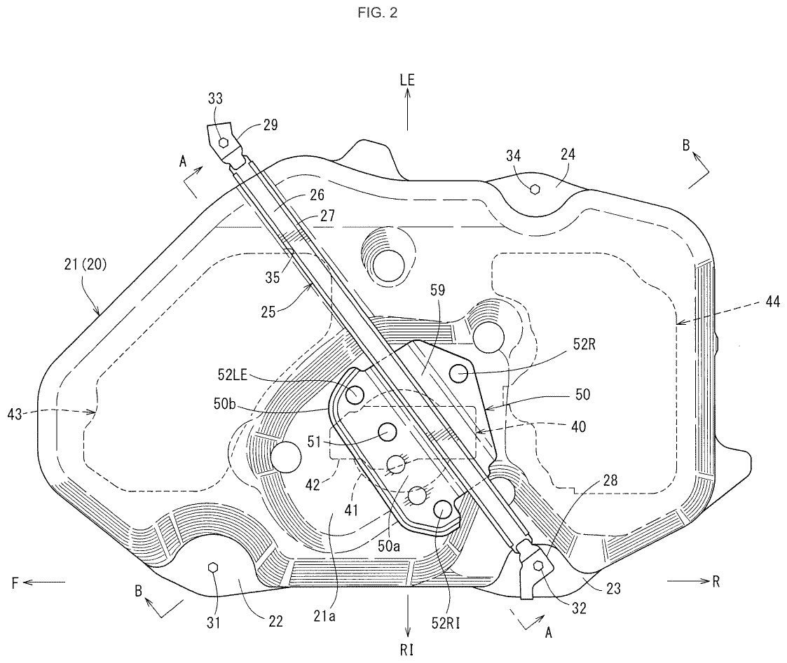

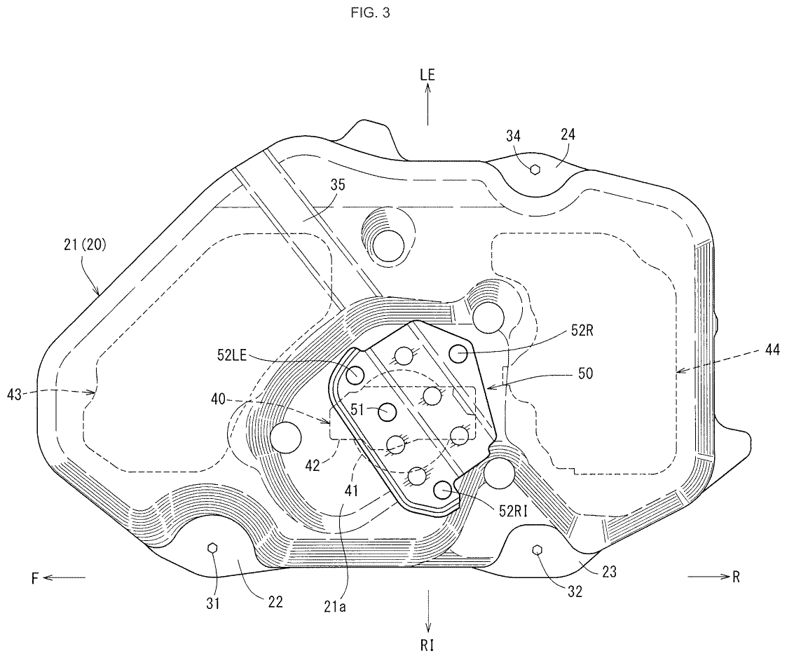

The drawings show a vehicle fuel tank structure, in which FIG. 1 is a bottom view of a substantial part of a vehicle including the vehicle fuel tank structure, FIG. 2 is an enlarged view of a substantial part of FIG. 1, and FIG. 3 is a bottom view of the fuel tank structure shown in a state where a tank band has been removed from FIG. 2.

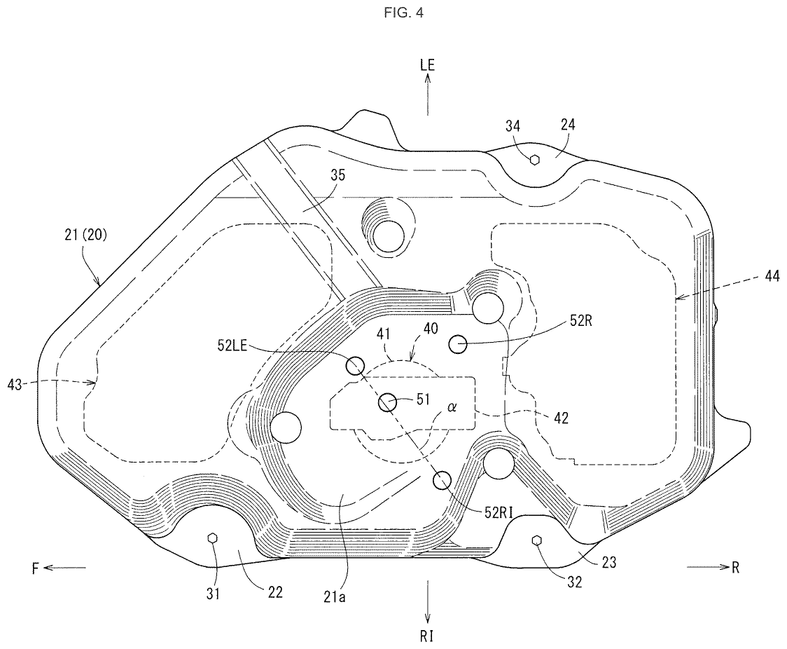

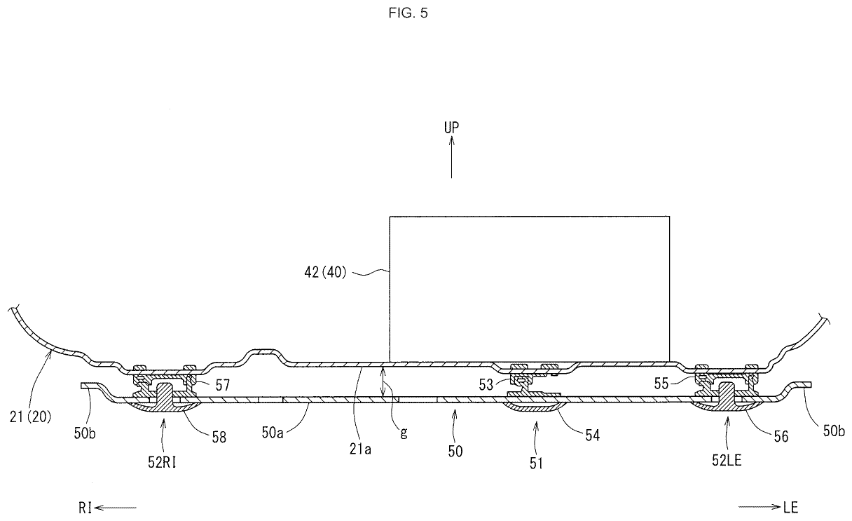

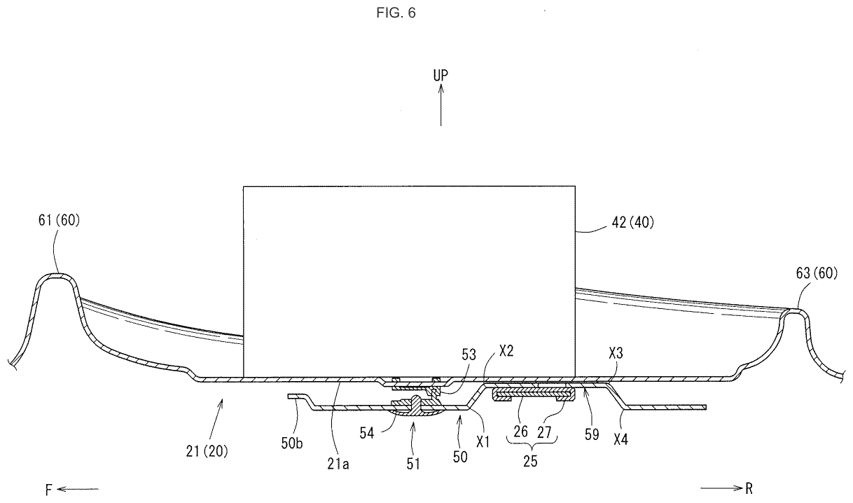

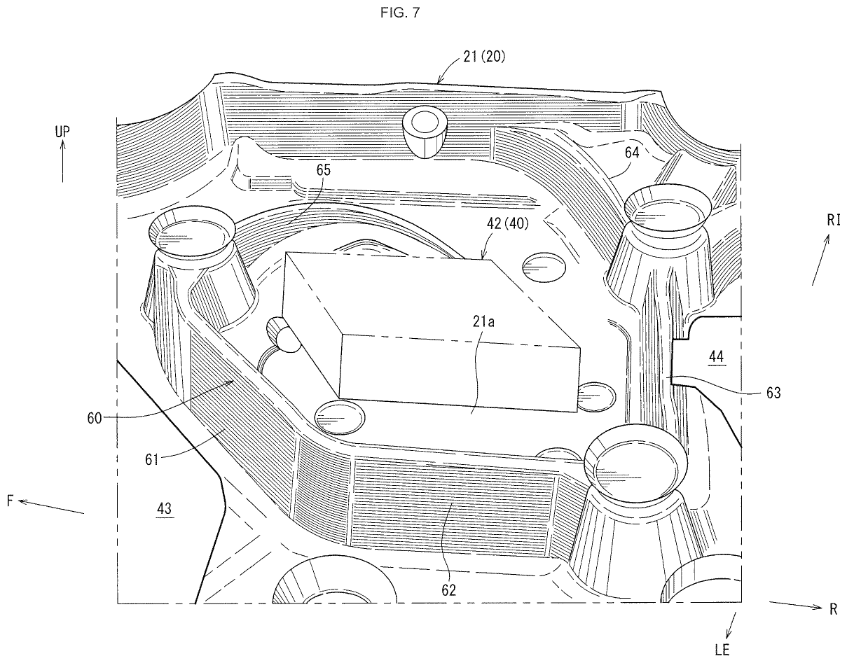

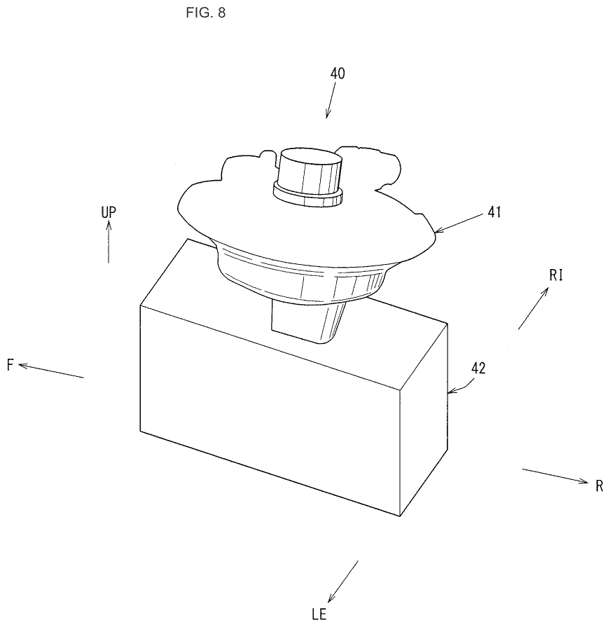

In addition, FIG. 4 is a bottom view of the fuel tank structure shown in a state where a reinforcement member has been removed from FIG. 3, FIG. 5 is a cross-sectional arrow view of a substantial part taken along a line A-A in FIG. 2, FIG. 6 is a cross-sectional arrow view of a substantial part taken along a line B-B in FIG. 2, FIG. 7 is a top perspective view which partially shows an internal structure of a fuel tank lower portion, and FIG. 8 shows a schematic perspective view of a fuel pump unit.

Prior to a description of the vehicle fuel tank structure, first, a lower vehicle-body structure of the vehicle will be described with reference to FIG. 1.

As shown in FIG. 1, a front floor panel 1 as a floor panel which forms a floor surface of a vehicle cabin is provided, and a rear seat pan 2 as a floor panel is connected to a rear end portion of the front floor panel 1 via a kick-up portion which rises upward and then extends rearward. A rear seat on which a rear seat occupant is to sit is mounted to an upper portion of the rear seat pan 2, and the feet of the rear seat occupant sitting on the rear seat is to be positioned in a rear part of the front floor panel 1 (above a fuel tank 20 to be described later).

In addition, a trunk floor 3 as a floor panel which forms a floor surface of a trunk is connected further to the rear of the rear seat pan 2 described above. A trunk recess which is formed by lowering the trunk floor 3 described above by a step is provided in an intermediate portion in a vehicle width direction of the trunk floor 3.

As shown in FIG. 1, a first cross member 4 (a so-called No. 3 cross member) which extends in the vehicle width direction is provided between the rear end portion of the front floor panel 1 described above and a front end portion of the rear seat pan 2. The first cross member 4 includes a cross member upper portion which forms the kick-up portion described above and a cross member lower portion 5, and a cross member closed cross-section 6 which extends in the vehicle width direction is formed between the cross member upper portion and the cross member lower portion 5 in order to improve rigidity of a lower vehicle-body structure.

In addition, as shown in FIG. 1, a second cross member 7 (a so-called No. 4 cross member) which extends in the vehicle width direction is provided between the rear end portion of the rear seat pan 2 and a front end portion of the trunk floor 3 described above. The second cross member 7 includes a cross member upper portion and a cross member lower portion 8, and a cross member closed cross-section 9 which extends in the vehicle width direction is formed between the cross member upper portion and the cross member lower portion 8 in order to improve rigidity of the lower vehicle-body structure.

The cross member lower portion 8 described above integrates, so as to extend in the vehicle width direction, three members formed in a divided manner including an intermediate member 8A which extends in the vehicle width direction and a left-side member 8B and a right-side member 8C which are positioned on both left and right end portions of the intermediate member 8A.

As shown in FIG. 1, a side sill 10 which extends in a vehicle front-rear direction is provided on both left and right sides in the vehicle width direction of the front floor panel 1 and the rear seat pan 2 described above. The side sill 10 includes a side sill outer portion and a side sill inner portion 11, and a side sill closed cross-section 12 which extends in the vehicle front-rear direction is formed between the side sill outer portion and the side sill inner portion 11 in order to improve rigidity of the lower vehicle-body structure. The side sill 10 described above extends toward front of the vehicle from a front portion of a rear wheel well to below a hinge pillar in a front portion of the vehicle.

In addition, as shown in FIG. 1, a rear side frame 13 which extends in the vehicle front-rear direction is provided on both left and right sides in the vehicle width direction of the rear seat pan 2 and the trunk floor 3 described above. The rear side frame 13 includes a rear side frame upper portion and a rear side frame lower portion 14, and a rear side closed cross-section 15 which extends in the vehicle front-rear direction is formed between the rear side frame upper portion and the rear side frame lower portion 14 in order to improve rigidity of the lower vehicle-body structure.

In this case, a front portion of the rear side frame lower portion 14 described above is positioned on a vehicle-width-direction inner side with respect to a rear portion of the side sill inner portion 11 and, at the same time, the front portion of the rear side frame lower portion 14 and a rear portion of the side sill inner portion 11 are provided so as to overlap with each other in a length range in the vehicle front-rear direction of the rear seat pan 2.

Furthermore, as shown in FIG. 1, an underfloor frame 16 is provided in a lower portion of the front floor panel 1 in a vicinity of a vehicle-width-direction inner side of the left and right side sill inner portions 11, a floor frame closed cross-section 17 which extends in the vehicle front-rear direction is provided between the lower portion of the front floor panel 1 and the underfloor frame 16 and, accordingly, rigidity of the lower vehicle-body structure is improved.

In addition, as shown in FIG. 1, a left-side connection bracket 18 is provided in a position offset to a left side in the vehicle width direction with respect to a center position in the vehicle width direction of the vehicle, and a lower portion of the rear seat pan 2 and the cross member lower portion 8 of the second cross member 7 are connected by the connection bracket 18.

In a similar manner, as shown in FIG. 1, a right-side connection bracket 19 is provided in a position offset to a right side in the vehicle width direction with respect to the center position in the vehicle width direction of the vehicle, and the lower portion of the rear seat pan 2 and the cross member lower portion 8 of the second cross member 7 are connected by the connection bracket 19. The left-side connection bracket 18 and the right-side connection bracket 19 described above are provided approximately left-right symmetrically with respect to a center portion in the vehicle width direction.

As shown in FIG. 1, the cross member lower portion 5 of the first cross member 4 described above connects the pair of left and right side sill inner portions 11 to each other in the vehicle width direction, and the cross member lower portion 8 of the second cross member 7 described above connects the pair of left and right rear side frame lower portions 14 to each other in the vehicle width direction.

Next, the vehicle fuel tank structure will be described with reference to FIGS. 1 to 8.

As shown in FIG. 1, the fuel tank 20 is provided below the floor panel. Specifically, as shown in FIG. 1, the fuel tank 20 is provided so as to straddle below the front floor panel 1 and below the rear seat pan 2. In the present example, as shown in FIG. 1, a center tank layout is adopted as a layout of the fuel tank 20 described above.

The fuel tank 20 is constructed by integrating two divided parts (an upper part and a lower part) being a fuel tank upper portion made of synthetic resin and a fuel tank lower portion 21 made of synthetic resin in order to store fuel therein.

A lower surface of the fuel tank lower portion 21 is covered from below the fuel tank lower portion 21 by an insulator and a protector, both not illustrated.

As shown in FIG. 1 and FIG. 2, in a peripheral edge portion of the fuel tank 20, flange-shaped tank fixation portions 22, 23, and 24 for fixing the fuel tank 20 to the vehicle body are integrally formed in respective sections on a front right side, a rear right side, and a rear left side.

A tank band 25 is provided which extends linearly from the rear right-side tank fixation portion 23 among the plurality of tank fixation portions 22, 23, and 24 toward front of the vehicle and toward outside on the left side in the vehicle width direction in a vehicle bottom view.

The tank band 25 includes a belt-like tank band body 26, a tank band holder 27 which extends along approximately an entire length in a longitudinal direction of the tank band body 26 and which holds the tank band body 26, a tank band fixation portion 28 on the rear side which is integrally provided in a rear end portion of the tank band body 26 being lead out from a right-side rear portion of the tank band holder 27, and a front-side tank band fixation portion 29 which is integrally provided in a front end portion of the tank band body 26 being lead out from a left-side front portion of the tank band holder 27.

As shown in FIG. 1, a fuel tank fixation bracket 30 is provided on the front floor panel 1 described above so as to oppose the front right-side tank fixation portion 22 among the plurality of tank fixation portions 22, 23, and 24. The fuel tank fixation bracket 30 is formed to as to protrude downward from a lower surface of the front floor panel 1.

In addition, as shown in FIG. 1, the front right-side tank fixation portion 22 is fixed to a lower portion of the fuel tank fixation bracket 30 described above using a fastening member 31 such as a bolt. In addition, as shown in FIG. 1, both the rear right-side tank fixation portion 23 and the tank band fixation portion 28 in the right-side rear portion are fixed by being co-fastened to a right-side lower portion in the vehicle width direction of the cross member lower portion 5 using a fastening member 32 such as a bolt.

Furthermore, as shown in FIG. 1, the tank band fixation portion 29 in a left-side front portion is fixed to a lower portion of the underfloor frame 16 on the left side in the vehicle width direction among the pair of left and right underfloor frames 16 using a fastening member 33 such as a bolt. In addition, as shown in FIG. 1, the tank fixation portion 24 on the left side in the rear portion is fixed to a left-side lower portion in the vehicle width direction of the cross member lower portion 5 using a fastening member 34 such as a bolt.

In other words, the fuel tank 20 described above is fixed to the vehicle body using the single tank band 25 and the plurality of fastening members 31, 32, 33, and 34 at a total of four fastening points which are spaced from each other in the vehicle front-rear direction and the vehicle width direction.

Accordingly, the fuel tank 20 is disposed below the floor panel via the tank band 25. In addition, a part of the tank band 25 is housed in a protruding portion 35 which is formed in a left portion in the vehicle width direction of the fuel tank lower portion 21 and which protrudes upward. As shown in FIG. 1 and FIG. 2, the protruding portion 35 described above is formed along a direction in which the tank band 25 is provided.

As shown in FIG. 4 and FIG. 8, a fuel pump unit 40 is provided in an intermediate portion in a front-rear direction inside the fuel tank 20. The fuel pump unit 40 includes a fuel pump unit upper portion 41 which is equipped with a fuel pump and a fuel pump unit lower portion 42, and the fuel pump unit upper portion 41 is pressed against the fuel pump unit lower portion 42 by an urging force of a spring. In other words, as shown in FIG. 5 and FIG. 6, the fuel pump unit 40 is fixed by being pressed against a tank bottom surface 21a of the fuel tank lower portion 21 as a tank bottom surface of the fuel tank 20 described above.

The fuel pump provided in the fuel pump unit upper portion 41 described above is a fuel supply device which sucks in and discharges fuel inside the fuel tank 20 and which supplies the fuel to an internal combustion engine, and the fuel pump unit upper portion 41 described above is pressed against the fuel pump unit lower portion 42 by an urging force of a spring for the purpose of eliminating a deficiency in fuel supply.

As shown in FIG. 2, FIG. 3, and FIG. 4, baffle plates 43 and 44 are provided at both front and rear positions across the fuel pump unit 40 inside the fuel tank 20 described above. The respective baffle plates 43 and 44 partition the inside of the fuel tank 20 to prevent the fuel inside the fuel tank 20 from becoming significantly choppy due to oscillations such as pitching (up-down movement of a head of a vehicle) and rolling (lateral oscillation), abrupt starting, and abrupt braking.

As shown in FIG. 3, FIG. 5, and FIG. 6, the fuel tank 20 described above is provided with a reinforcement plate 50 as a reinforcement member fixed to a vehicle-exterior side of the tank bottom surface 21a against which the fuel pump unit 40 is pressed.

As shown in FIG. 3, the reinforcement plate 50 described above includes a single first fixation portion 51 and a plurality of second fixation portions 52LE, 52RI, and 52R. In other words, the reinforcement plate is fixed to the vehicle-exterior side of the tank bottom surface 21a of the fuel tank lower portion 21 via the first fixation portion 51 and the plurality of second fixation portions 52LE, 52RI, and 52R.

Among the plurality of second fixation portions 52LE, 52RI, and 52R, the second fixation portion 52LE (a left-side second fixation portion) is positioned on the left side in the vehicle width direction with respect to the first fixation portion 51, the second fixation portion 52RI (a right-side second fixation portion) is positioned on the right side in the vehicle width direction with respect to the first fixation portion 51, and the second fixation portion 52R (a rear-side second fixation portion) is positioned on the rear side in the vehicle front-rear direction with respect to the first fixation portion 51.

The first fixation portion 51 described above is fixed to the tank bottom surface 21a of the fuel tank lower portion 21 at a section against which the fuel pump unit 40 is pressed in a plan view or, in other words, at a position overlapping with the fuel pump unit lower portion 42.

In addition, the respective second fixation portions 52LE, 52RI, and 52R described above are fixed to the tank bottom surface 21a of the fuel tank lower portion 21 at sections against which the fuel pump unit 40 is pressed in a plan view or, in other words, at positions not overlapping with the fuel pump unit lower portion 42.

In simple terms, the first fixation portion 51 described above is provided at a vibration transmission section to which vibration from the fuel pump of the fuel pump unit 40 is transmitted, and the plurality of second fixation portions 52LE, 52RI, and 52R are provided at peripheral positions which are spaced from a vibration generation position.

As shown in FIG. 5 and FIG. 6, the first fixation portion 51 described above includes a retainer 53 provided on the tank bottom surface 21a and a rivet 54 for fixing the reinforcement plate 50 to the tank bottom surface 21a via the retainer 53.

As shown in FIG. 5, the second fixation portion 52LE described above includes a retainer 55 provided on the tank bottom surface 21a and a rivet 56 for fixing the reinforcement plate 50 to the tank bottom surface 21a via the retainer 55.

In a similar manner, the second fixation portion 52RI described above includes a retainer 57 provided on the tank bottom surface 21a and a rivet 58 for fixing the reinforcement plate 50 to the tank bottom surface 21a via the retainer 57.

In addition, the second fixation portion 52R described above also includes a retainer provided on the tank bottom surface 21a and a rivet for fixing the reinforcement plate 50 to the tank bottom surface 21a via the retainer.

In this case, the respective retainers 53, 55, and 57 described above are formed of a same synthetic resin as the fuel tank 20 while the respective rivets 54, 56, and 58 described above are formed of, for example, polyamide 66 (so-called nylon 66).

Note that the first fixation portion 51 and the second fixation portions 52LE, 52RI, and 52R are not limited to being fixed by rivets and may be fastened using nuts and bolts.

As described above, the reinforcement plate 50 includes the first fixation portion 51 which is fixed to the tank bottom surface 21a of the fuel tank lower portion 21 at a position overlapping with a section against which the fuel pump unit 40 is pressed in a plan view and the plurality of second fixation portions 52LE, 52RI, and 52R which are fixed to the tank bottom surface 21a of the fuel tank lower portion 21 at positions not overlapping with a section against which the fuel pump unit 40 is pressed in a plan view.

Although vibration from the fuel pump of the fuel pump unit 40 is transmitted to the tank bottom surface 21a described above, since the reinforcement plate 50 is fixed by the first fixation portion 51 to be a vibration generation position and the second fixation portions 52LE, 52RI, and 52R at positions spaced from the vibration generation position, rigidity of the tank bottom surface 21a in a periphery of a vibration source is improved and vibration of the fuel tank 20 is suppressed.

Accordingly, a configuration is adopted in order to suppress the transmission of the vibration of the fuel pump unit 40 to the vehicle body without depending on a rubber mount.

The second fixation portions 52LE, 52RI, and 52R described above include a plurality of fixation portions, and the first fixation portion 51 described above is disposed on an imaginary line α (refer to FIG. 4) connecting the plurality of second fixation portions described above to each other.

Specifically, as shown in FIG. 4, the first fixation portion 51 described above is disposed on the imaginary line α connecting the left-side second fixation portion 52LE and the right-side second fixation portion 52RI to each other.

Accordingly, a configuration is adopted in which the first fixation portion 51 is pressed via the reinforcement plate 50 at the second fixation portions 52LE and 52RI which are positioned on the imaginary line α described above and, as a result, a vibration of the first fixation portion 51 to be a vibration generation position can be suppressed in an efficient manner.

As shown in FIG. 2, the tank band 25 which supports the fuel tank 20 is disposed in a lower portion of the reinforcement plate 50 between the first fixation portion 51 described above and the second fixation portion 52R on the rear side described above.

Accordingly, a configuration is adopted which causes the reinforcement plate 50 to press against the tank bottom surface 21a including the tank band 25 to further suppress the vibration of the tank bottom surface 21a.

As shown in FIG. 2 and FIG. 6, the reinforcement plate 50 described above includes, between the first fixation portion 51 and the second fixation portion 52R on the rear side, a ridge portion 59 which houses the tank band 25, which protrudes upward, and which is provided along the tank band 25.

Accordingly, suppression of the vibration of the tank bottom surface 21a can be achieved by suppressing a bending deformation of the reinforcement plate 50 due to input of vibration in an up-down direction with the ridge portion 59 and the tank band 25 which is housed in the ridge portion 59.

Specifically, due to the formation of the ridge portion 59 described above, a ridge X1 in a front-side lower portion, a ridge X2 in a front-side upper portion, a ridge X3 in a rear-side upper portion, and a ridge X4 in a rear-side lower portion are formed in the reinforcement plate 50 described above as shown in FIG. 6 and an improvement in rigidity of the reinforcement plate 50 is achieved by the plurality of ridges X1 to X4.

As shown in FIG. 5, the tank bottom surface 21a of the fuel tank lower portion 21 in the fuel tank 20 described above and the reinforcement plate 50 described above are disposed spaced apart in the up-down direction. In other words, a gap g in the up-down direction is formed between the tank bottom surface 21a of the fuel tank lower portion 21 and a main surface portion 50a (a portion where the ridge portion 59 and outer-side flange portions 50b and 50c are not formed) of the reinforcement plate 50.

As described above, due to the reinforcement plate 50 described above being spaced from the tank bottom surface 21a in the up-down direction, the reinforcement plate 50 can be made a structure capable of increasing a moment of inertia of area and, accordingly, a configuration is adopted which improves rigidity of the reinforcement plate 50.

As shown in FIG. 6 and FIG. 7, a raised wall 60 with an outer hull (outer enclosure)-shape which protrudes toward an inside of the fuel tank 20 from the tank bottom surface 21a and which covers a circumference of the fuel pump unit lower portion 42 of the fuel pump unit 40 is formed on the tank bottom surface 21a of the fuel tank lower portion 21 in the fuel tank 20.

In addition, the reinforcement plate 50 described above is disposed at a position opposing an inside area of the raised wall 60 described above. While the raised wall 60 described above is integrally formed with the tank bottom surface 21a in the present example, alternatively, a structure provided with a raised wall which is separate from the fuel tank 20 may be adopted.

By providing the raised wall 60 which covers the circumference of the fuel pump unit lower portion 42 as described above, the inside area of the raised wall 60 with low rigidity can be reinforced in an efficient manner by the reinforcement plate 50 while eliminating a deficiency in fuel intake of the fuel pump during rolling of the vehicle and the like with the raised wall 60.

As shown in FIG. 7, the raised wall 60 described above includes a front wall 61 which covers the front of the fuel pump unit lower portion 42, a left wall 62 which covers the left in the vehicle width direction of the fuel pump unit lower portion 42, a rear wall 63 which covers the rear of the fuel pump unit lower portion 42, a right rear wall 64 which covers the right in the vehicle width direction and the rear of the fuel pump unit lower portion 42, and a front right wall 65 which covers the front and the right in the vehicle width direction of the fuel pump unit lower portion 42.

A wall height of the front right wall 65 described above gradually decreases from a front end portion toward a rear end portion, and a height of a rear end of the front right wall 65 matches a height of the tank bottom surface 21a.

In addition, as shown in FIG. 6, the tank bottom surface 21a described above which the fuel pump unit lower portion 42 in the fuel pump unit 40 is pressed against is constructed as a flat surface.

Although the tank bottom surface 21a constructed by a flat surface as described above readily deforms, a configuration is adopted in which the tank bottom surface 21a is reliably reinforced by the reinforcement plate 50 which is fixed by the first fixation portion 51 and the second fixation portions 52LE, 52RI, and 52R.

In the drawings, an arrow F indicates the front of the vehicle, an arrow R indicates the rear of the vehicle, an arrow UP indicates above the vehicle, an arrow LE indicates left outward in the vehicle width direction, and an arrow RI indicates right outward in the vehicle width direction.

As described above, the vehicle fuel tank structure according to the present example includes: the fuel tank 20 provided below the floor panel (refer to the front floor panel 1 and the rear seat pan 2); the fuel pump unit 40 which is provided inside the fuel tank 20 and which is fixed by being pressed against the tank bottom surface 21a of the fuel tank 20; and the reinforcement member (the reinforcement plate 50) fixed to a vehicle-exterior side of the tank bottom surface 21a against which the fuel pump unit 40 of the fuel tank 20 is pressed, the vehicle fuel tank structure characterized in that the reinforcement member (the reinforcement plate 50) includes: the first fixation portion 51 which is fixed to the fuel tank 20 at a position overlapping with a section against which the fuel pump unit 40 described above is pressed in a plan view; and the second fixation portions 52LE, 52RI, and 52R which are fixed to the fuel tank 20 at positions not overlapping with the section against which the fuel pump unit 40 is pressed in a plan view (refer to FIGS. 1 to 3 and FIG. 8).

According to the vehicle fuel tank structure described above, although vibration from the fuel pump of the fuel pump unit 40 is transmitted to the tank bottom surface 21a, since the reinforcement member (the reinforcement plate 50) is fixed by the first fixation portion 51 to be a vibration generation position and the second fixation portions 52LE, 52RI, and 52R at positions spaced from the vibration generation position, rigidity of the tank bottom surface 21a in a periphery of a vibration source can be improved and vibration of the fuel tank 20 can be suppressed.

Therefore, the transmission of the vibration of the fuel pump unit 40 to the vehicle body can be suppressed without depending on a rubber mount.

In addition, in the vehicle fuel tank structure, the second fixation portions 52LE, 52RI, and 52R described above include a plurality of fixation portions, and the first fixation portion 51 described above is disposed on the imaginary line α connecting the plurality of second fixation portions (the second fixation portions 52LE and 52RI) to each other (refer to FIG. 4).

According to the vehicle fuel tank structure described above, since the first fixation portion 51 is pressed via the reinforcement member (the reinforcement plate 50) at the second fixation portions 52LE and 52RI which are positioned on the imaginary line a, a vibration of the first fixation portion 51 to be a vibration generation position can be suppressed in an efficient manner.

Furthermore, in the vehicle fuel tank structure, the tank band 25 which supports the fuel tank 20 described above is disposed between the first fixation portion 51 described above and the second fixation portion 52R on the rear side described above (refer to FIG. 2).

According to the vehicle fuel tank structure described above, by causing the reinforcement member (the reinforcement plate 50) to press against the tank bottom surface 21a including the tank band 25, the vibration of the tank bottom surface 21a can be further suppressed.

Moreover, in the vehicle fuel tank structure, the reinforcement member (the reinforcement plate 50) described above includes the ridge portion 59 which houses the tank band 25 described above and which protrudes upward (refer to FIG. 4 and FIG. 6).

According to the vehicle fuel tank structure described above, suppression of the vibration of the tank bottom surface 21a can be achieved by suppressing a bending deformation of the reinforcement member (the reinforcement plate 50) due to input of vibration in an up-down direction with the ridge portion 59 and the tank band 25 which is housed in the ridge portion 59.

In addition, in the vehicle fuel tank structure, the tank bottom surface 21a of the fuel tank 20 described above and the reinforcement member (the reinforcement plate 50) described above are disposed spaced apart in the up-down direction (refer to FIG. 5).

According to the vehicle fuel tank structure described above, due to the reinforcement member (the reinforcement plate 50) described above being spaced from the tank bottom surface 21a in the up-down direction, the reinforcement member (the reinforcement plate 50) can be made a structure capable of increasing a moment of inertia of area and, accordingly, rigidity of the reinforcement member (the reinforcement plate 50) can be improved.

Furthermore, in the vehicle fuel tank structure, the tank bottom surface 21a of the fuel tank 20 includes the raised wall 60 which protrudes toward an inside of the tank from the tank bottom surface 21a and which covers a circumference of the fuel pump unit 40 (specifically, refer to the fuel pump unit lower portion 42), and the reinforcement member (the reinforcement plate 50) is disposed at a position which opposes an inside area of the raised wall 60 described above (refer to FIG. 6 and FIG. 7).

According to the vehicle fuel tank structure described above, the inside area of the raised wall 60 with low rigidity can be reinforced in an efficient manner by the reinforcement member (the reinforcement plate 50) while eliminating a deficiency in fuel intake of the fuel pump during rolling of the vehicle with the raised wall 60.

Moreover, in the vehicle fuel tank structure, the tank bottom surface 21a described above which the fuel pump unit 40 described above is pressed against is constructed as a flat surface (refer to FIG. 5).

According to the vehicle fuel tank structure described above, although the tank bottom surface 21a constructed by a flat surface as described above readily deforms, the tank bottom surface 21a is reliably reinforced by the reinforcement member (the reinforcement plate 50) which is fixed by the first fixation portion 51 and the second fixation portions 52LE, 52RI, and 52R.

In a correspondence between the configuration of the present disclosure and the example described above, while the floor panel according to the present disclosure corresponds to the front floor panel 1 and the rear seat pan 2 according to the example, and
similarly hereinafter,
the fuel tank corresponds to the fuel tank 20,
the tank bottom surface corresponds to the tank bottom surface 21a,
the tank band corresponds to the tank band 25,
the fuel pump unit corresponds to the fuel pump unit 40,
the reinforcement member corresponds to the reinforcement plate 50,
the first fixation portion corresponds to the first fixation portion 51,
the second fixation portion corresponds to the second fixation portions 52LE, 52RI, and 52R,
the ridge portion corresponds to the ridge portion 59,
   the raised wall corresponds to the raised wall 60, and
the imaginary line connecting the left-side second fixation portion and the right-side second fixation portion corresponds to the imaginary line α,
it is to be understood that the present disclosure is not solely limited to the configuration of the example described above and many embodiments can be obtained.

### INDUSTRIAL APPLICABILITY

As described above, the present disclosure is useful with respect to a vehicle fuel tank structure including a fuel tank which is provided below a floor panel and a fuel pump unit which is provided inside the fuel tank and which is fixed by being pressed against a tank bottom surface of the fuel tank.

1. A vehicle fuel tank structure, comprising:
a fuel tank provided below a floor panel;
a fuel pump which is provided inside the fuel tank and which is fixed by being pressed against a tank bottom surface of the fuel tank; and
a reinforcement member fixed to a vehicle-exterior side of the tank bottom surface against which the fuel pump of the fuel tank is pressed, wherein
the reinforcement member includes
a first fixation portion which is fixed to the fuel tank at a position overlapping with a section against which the fuel pump is pressed in a plan view; and
a second fixation portion which is fixed to the fuel tank at a position not overlapping with the section against which the fuel pump is pressed in a plan view.

2. The vehicle fuel tank structure according to claim 1, wherein
the second fixation portion includes a plurality of fixation portions, and
the first fixation portion is disposed on an imaginary line connecting the plurality of second fixation portions to each other.

3. The vehicle fuel tank structure according to claim 2, wherein
a tank band for supporting the fuel tank is disposed between the first fixation portion and the second fixation portion on a rear side.

4. The vehicle fuel tank structure according to claim 3, wherein
the reinforcement member includes a ridge portion which protrudes upward and which houses the tank band.

5. The vehicle fuel tank structure according to claim 1, wherein
the tank bottom surface of the fuel tank and the reinforcement member are disposed spaced from each other in an up-down direction.

6. The vehicle fuel tank structure according to claim 2, wherein
the tank bottom surface of the fuel tank and the reinforcement member are disposed spaced from each other in an up-down direction.

7. The vehicle fuel tank structure according to claim 3, wherein
the tank bottom surface of the fuel tank and the reinforcement member are disposed spaced from each other in an up-down direction.

8. The vehicle fuel tank structure according to claim 4, wherein
the tank bottom surface of the fuel tank and the reinforcement member are disposed spaced from each other in an up-down direction.

9. The vehicle fuel tank structure according to claim 1, wherein
the tank bottom surface of the fuel tank includes a raised wall which protrudes toward an inside of the tank from the tank bottom surface and which covers a circumference of the fuel pump, and
the reinforcement member is disposed at a position which opposes an inside area of the raised wall.

10. The vehicle fuel tank structure according to claim 2, wherein
the tank bottom surface of the fuel tank includes a raised wall which protrudes toward an inside of the tank from the tank bottom surface and which covers a circumference of the fuel pump, and
the reinforcement member is disposed at a position which opposes an inside area of the raised wall.

11. The vehicle fuel tank structure according to claim 3, wherein
the tank bottom surface of the fuel tank includes a raised wall which protrudes toward an inside of the tank from the tank bottom surface and which covers a circumference of the fuel pump, and
the reinforcement member is disposed at a position which opposes an inside area of the raised wall.

12. The vehicle fuel tank structure according to claim 4, wherein
the tank bottom surface of the fuel tank includes a raised wall which protrudes toward an inside of the tank from the tank bottom surface and which covers a circumference of the fuel pump, and
the reinforcement member is disposed at a position which opposes an inside area of the raised wall.

13. The vehicle fuel tank structure according to claim 5, wherein
the tank bottom surface of the fuel tank includes a raised wall which protrudes toward an inside of the tank from the tank bottom surface and which covers a circumference of the fuel pump, and
the reinforcement member is disposed at a position which opposes an inside area of the raised wall.

14. The vehicle fuel tank structure according to claim 6, wherein
the tank bottom surface of the fuel tank includes a raised wall which protrudes toward an inside of the tank from the tank bottom surface and which covers a circumference of the fuel pump, and
the reinforcement member is disposed at a position which opposes an inside area of the raised wall.

15. The vehicle fuel tank structure according to claim 7, wherein
the tank bottom surface of the fuel tank includes a raised wall which protrudes toward an inside of the tank from the tank bottom surface and which covers a circumference of the fuel pump, and
the reinforcement member is disposed at a position which opposes an inside area of the raised wall.

16. The vehicle fuel tank structure according to claim 8, wherein
the tank bottom surface of the fuel tank includes a raised wall which protrudes toward an inside of the tank from the tank bottom surface and which covers a circumference of the fuel pump, and
the reinforcement member is disposed at a position which opposes an inside area of the raised wall.

17. The vehicle fuel tank structure according to claim 1, wherein
the tank bottom surface against which the fuel pump unit is pressed is constructed as a flat surface.

18. The vehicle fuel tank structure according to claim 5, wherein
the tank bottom surface against which the fuel pump unit is pressed is constructed as a flat surface.

19. The vehicle fuel tank structure according to claim 9, wherein
the tank bottom surface against which the fuel pump unit is pressed is constructed as a flat surface.

20. The vehicle fuel tank structure according to claim 13, wherein
the tank bottom surface against which the fuel pump unit is pressed is constructed as a flat surface.
